(19) United States
(12) Patent Application Publication
(10) Pub. No.: US 2010/0328284 A1
(43) Pub. Date: Dec. 30, 2010

(54) ELECTRONIC APPARATUS

(76) Inventor: Ryosuke NOGUCHI, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/820,622

(22) Filed: Jun. 22, 2010

(30) Foreign Application Priority Data
Jun. 30, 2009 (JP) 2009-154792

(51) Int. Cl. G09G 5/00; H05B 37/02

(52) U.S. Cl. 345/207; 315/307

(57) ABSTRACT

An electronic apparatus includes, a power consuming unit that consumes electric power with operation of the electronic apparatus, a detection unit for detecting illumination intensity of light in an environment where the electronic apparatus is located, and a change unit that changes an operating state of the power consuming unit from a first state to a second state when an amount of change in the illumination intensity that is calculated from the illumination intensity detected by the detection unit, is equal to or larger than a predetermined threshold.

### CROSS-REFERENCE TO RELATED APPLICATION(S)

This application is related to and claims priority to Japanese Patent Application No. 2009-154792, filed on Jun. 30, 2009, and incorporated herein by reference.

### BACKGROUND

1. Field

The embodiments discussed herein are directed to an electronic apparatus.

2. Description of the Related Art

Conventionally, an electronic apparatus when, for example, a manipulation input from a user is not detected for a certain time or longer, an operating mode (operating state) of the electronic apparatus may be changed from an normal mode (normal operating state) to a standby mode (power-saving state) for the purpose of reducing power consumption. The term “standby mode” may be defined as an operating mode of the electronic apparatus in which power consumption is held smaller than that in the normal mode. Conventionally, in electronic apparatuses, however, even when the user leaves the electronic apparatus, the operating mode is not changed to the standby mode unless the certain time elapses, and hence wasteful power is consumed. Taking into account such a situation, an electronic apparatus is proposed in which brightness (illumination intensity or illuminance) in the surroundings of the electronic apparatus is detected by a sensor and an operating mode of the electronic apparatus is changed over between an normal mode and a standby mode (power-saving state) based on the detected illumination intensity (see, e.g., Japanese Unexamined Patent Application Publication No. 2007-323257, No. 2002-169446, 2007-280512, and No. 2004-175099).

### SUMMARY

It is an aspect of the embodiments discussed herein to provide an electronic apparatus, a state control method and a non-transitory recording medium.

The above aspects can be attained by a an electronic apparatus that includes, a power consuming unit which consumes electric power with operation thereof, a detection unit for detecting illumination intensity of light in an environment where the power consuming unit is located, and a change unit for changing an operating state of the power consuming unit from a first state to a second state when an amount of change in the illumination intensity, which is calculated from the illumination intensity detected by the detection unit, is equal to or larger than a predetermined threshold.

The above aspects can be attained by a state control method executed by an electronic apparatus, the method including consuming electric power with operation of the electronic apparatus by a power consuming unit, detecting illumination intensity of light in an environment where the electronic apparatus is located, and changing an operating state of the power consuming unit from a first state to a second state when an amount of change in the illumination intensity that is calculated from the detected illumination intensity, is equal to or larger than a predetermined threshold.

The above aspects can be attained a non-transitory recording medium which is computer-readable and records a program executed by an electronic apparatus, the program causing the electronic apparatus to execute a state control method including consuming electric power with operation of the electronic apparatus by a power consuming unit;

detecting illumination intensity of light in an environment where the electronic apparatus is located; and changing an operating state of the power consuming unit from a first state to a second state when an amount of change in the illumination intensity, that is calculated from the detected illumination intensity, is equal to or larger than a predetermined threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary notebook PC;

FIG. 2 illustrates an exemplary configuration when a PC is the desktop type;

FIG. 3 illustrates an exemplary TV set;

FIG. 4 illustrates an exemplary information processing unit;

FIG. 5 illustrates exemplary processing executed by a change unit;

FIG. 6 illustrates exemplary processing executed by the change unit;

FIG. 7 illustrates exemplary processing executed by the change unit;

FIG. 8 illustrates an exemplary relationship between change in the illumination intensity of light in an environment where the PC is located and an operating mode;

FIG. 9 illustrates an exemplary relationship between the change in the illumination intensity of light in the environment where the PC is located and the operating mode;

FIG. 10 illustrates an exemplary relationship between the change in the illumination intensity of light in the environment where the PC is located and the operating mode; and

FIG. 11 illustrates exemplary changes of the operating mode of the PC with respect to an ambient environment and user work.

### DESCRIPTION OF THE EMBODIMENTS

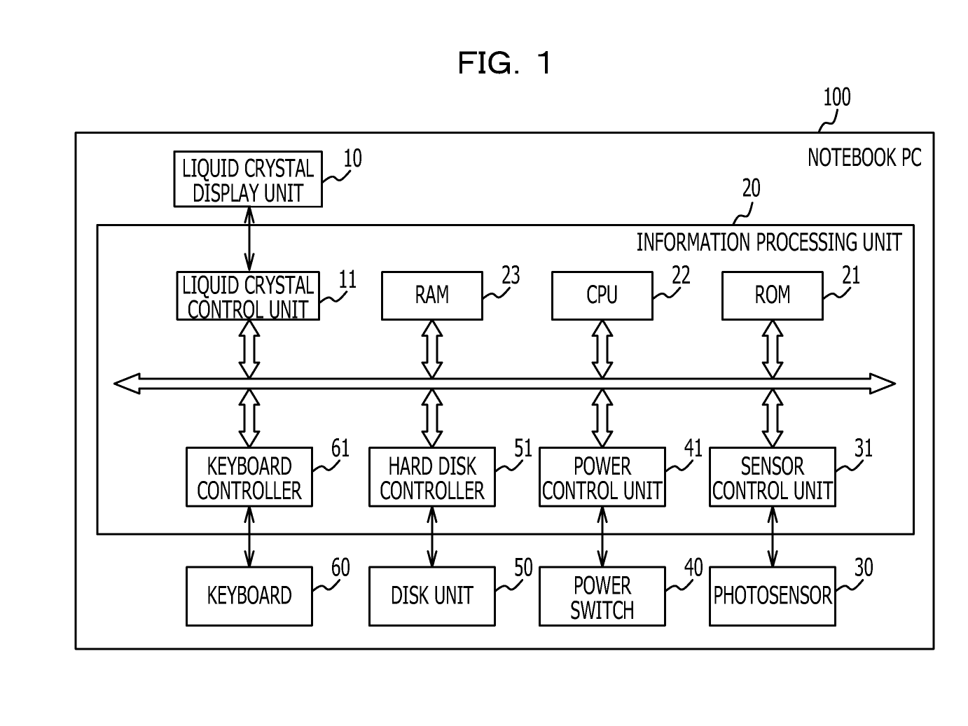

A notebook personal computer (“personal computer” being abbreviated to a “PC” hereinafter) is an example of an electronic apparatus disclosed herein. FIG. 1 illustrates an exemplary configuration of a notebook PC.

A PC 100 includes a liquid crystal display unit 10, an information processing unit 20, a photosensor (detection unit) 30, a power switch 40, a disk unit 50, and a keyboard 60.

The liquid crystal display unit 10 displays image and character information. The liquid crystal display unit 10 may be a touch panel. In such a case, the touch panel serves as a data input device.

The photosensor 30 may be mounted to the PC 100 and detects the illumination intensity of light in the surroundings of the PC 100. The number of photosensor(s) 30 mounted to the PC 100 may be single or plural.

The power switch 40 turns ON and OFF electric power supplied to the PC 100.

The keyboard 60 is a data input device. In addition to the keyboard 60, a mouse, a joystick, etc. can also be connected, as the data input device, to the information processing unit 20.

The disk unit 50 is an external storage and stores data and temporarily stores the contents of a RAM.

The information processing unit 20 executes information processing based on signals received from the photosensor 30, the power switch 40 and the keyboard 60, thereby controlling entire operation of the PC 100. The information processing unit 20 includes a ROM (Read Only Memory) 21, a CPU (Central Processing Unit) 22, and a RAM (Random Access Memory) 23. Further, the information processing unit 20 includes a liquid crystal control unit 11 serving as an input/output unit which inputs and outputs signals with respect to various components connected to the information processing unit 20, a keyboard controller 61, a hard disk controller 51, a power control unit 41, and a sensor control unit 31.

The liquid crystal control unit 11 outputs signals of image and character information to the liquid crystal display unit 10. When the liquid crystal display unit 10 employs a touch panel, the liquid crystal control unit 11 acquires, e.g., information of a position where, for example, a user's finger touches the touch panel of the liquid crystal display unit 10. Further, the liquid crystal control unit 11 controls an operating mode of the liquid crystal display unit 10.

The ROM 21 stores programs for use in control of the PC 100, a program (described in detail later) for determining an operating mode of the PC 100. The CPU 22 reads the programs stored in the ROM 21 and executes them. The RAM 23 stores temporary data that is used when the programs are executed.

The sensor control unit 31 controls, for example, the timing at which the photosensor 30 detects the illumination intensity. As a result, the illumination intensity detected by the photosensor 30 is input to the sensor control unit 31 at the controlled timing.

The power control unit 41 controls the power supplied to the PC 100.

The hard disk controller 51 controls write and read of data to and from the disk unit 50.

The keyboard controller 61 receives various data inputs from the keyboard 60.

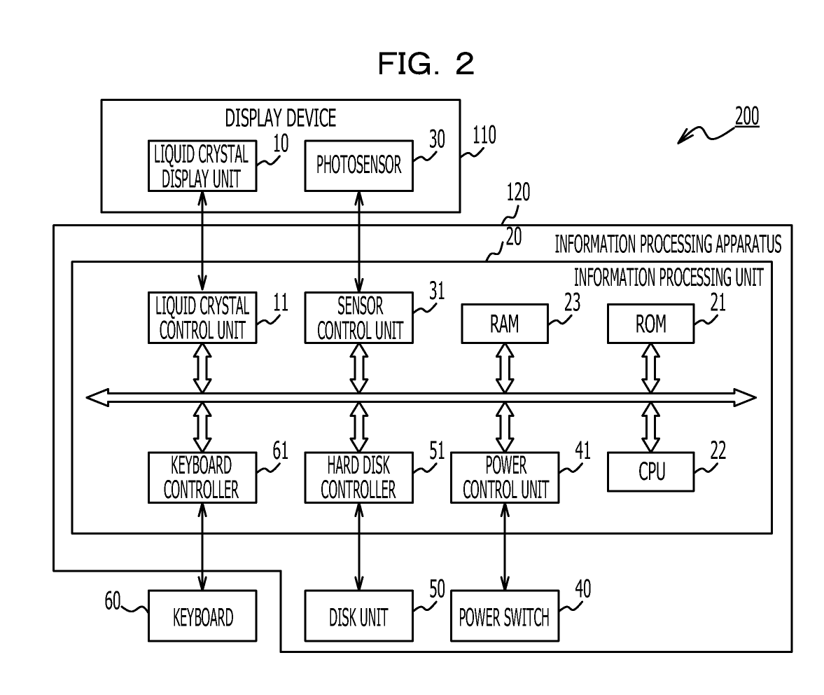

While the notebook PC is employed as one example of the electronic apparatus disclosed herein, the PC may be a desktop PC as another example of the electronic apparatus. FIG. 2 illustrates an exemplary PC 200 that is a desktop PC.

A desktop type PC 200 includes a display device 110, an information processing apparatus 120, and a keyboard 60 connected to the information processing apparatus 120. The keyboard 60 and an information processing unit 20, a power switch 40, and a disk unit 50 included in the information processing apparatus 120, are similar to those illustrated in FIG. 1, and therefore descriptions of those components are omitted.

The display device 110 includes a liquid crystal display unit 210 and a photosensor 30. The liquid crystal display unit 210 is included in the display device 110 which is separate from the information processing apparatus 120, but serves a similar function as liquid crystal display unit 10 illustrated in FIG. 1. The desktop PC including the display device 110 and the information processing apparatus 120 in integral form may serve as the electronic apparatus disclosed herein.

The photosensor 30 may be mounted to, e.g., a front surface, a rear surface, or a lateral surface of the display device 110. Alternatively, the photosensor 30 may be mounted to the information processing apparatus 120 instead of the display device 110. Further, the photosensor 30 may be mounted onto, for example, a desk on which the user employs the PC, instead of the display device 110 and the information processing apparatus 120.

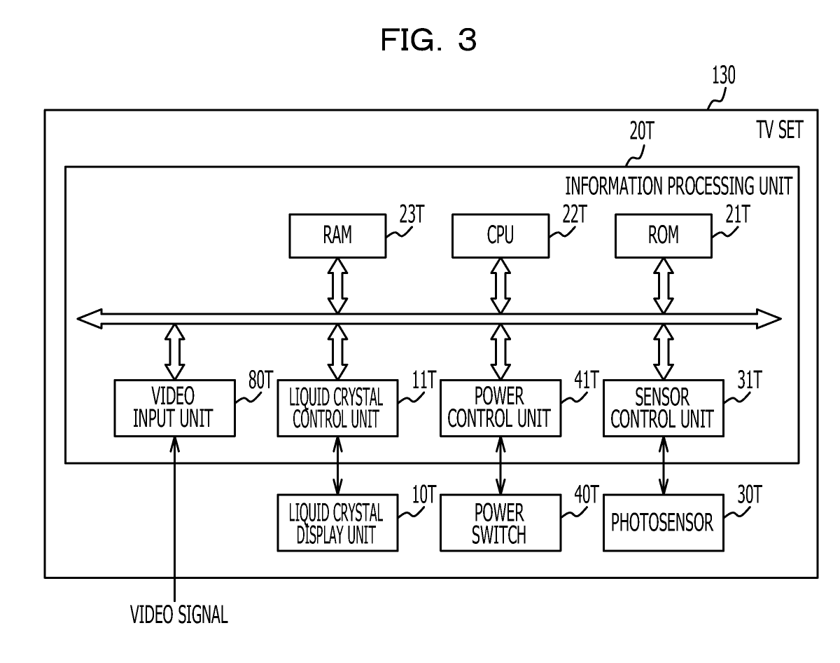

A TV set illustrated in FIG. 3 may be used as still another example of the electronic apparatus disclosed herein. FIG. 3 illustrates an exemplary configuration of the TV set.

A TV set 130 includes a liquid crystal display unit 10T, an information processing unit 20T, a photosensor 30T, and a power switch 40T. The information processing unit 20T includes a CPU 22T, a RAM 23T, and a ROM 21T. Further, the information processing unit 20T includes a liquid crystal control unit 11T serving as an input/output unit which inputs and outputs signals with respect to various components connected to the information processing unit 20T, a power control unit 41T, a sensor control unit 31, and a video input unit BOT.

Similar components of the TV set 130 as those of the PC 100 are denoted by the same reference numerals by suffixing “T” to the reference numerals used in FIG. 1, and descriptions of those components are omitted. The video input unit SOT receives a video signal distributed from a broadcasting station, for example, and outputs the received video signal to the liquid crystal display unit 10T through the liquid crystal control unit 11T.

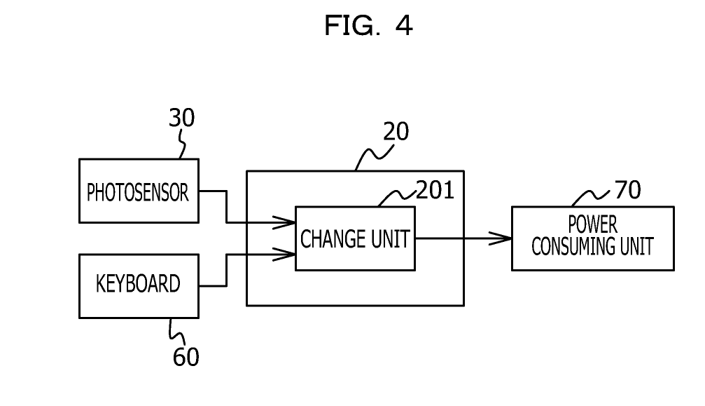

FIG. 4 illustrates an information processing unit 20. The liquid crystal display unit 10 and the information processing unit 20, consume electric power with operations thereof. In an exemplary embodiment, therefore, the liquid crystal display unit 10 and the information processing unit 20 are collectively referred to as a power consuming unit 70.

The information processing unit 20 includes a change unit 201. A CPU 22 may serve as a change unit 201 by executing the program stored in the ROM 21. Inputting (acquisition) and outputting of signals used in executing the program stored in the ROM 21 are performed with the aid of various hardware components through the liquid crystal control unit 11, the sensor control unit 31, the keyboard controller 61, etc.

The change unit 201 acquires, from the photosensor 30, the illumination intensity of light in the environment where the PC 100 is located at constant time intervals (e.g., 1 sec). Depending on an amount of increase or decrease in the illumination intensity of light per unit time which has been acquired from the photosensor 30, the change unit 201 changes an operating mode of the power consuming unit 70 among an normal mode (normal operating state), a standby mode (power-saving mode), and a ready mode (ready state or display-down state). Herein, the term “normal mode” implies that, in the power consuming unit 70 according to this embodiment, the liquid crystal display unit 10 and the information processing unit 20 are both in an normal operating state. The term “ready mode” implies that, in the power consuming unit 70, the liquid crystal display unit 10 is in a power-saving state in which it neither receives supply of electric power nor displays any image, while the information processing unit 20 is in the normal operating state. The term “standby mode” implies that, in the power consuming unit 70, the liquid crystal display unit 10 and the information processing unit 20 are both in the power-saving state. Power consumption reduces in the order of the normal mode, the ready mode, and the standby mode.

Further, the change unit 201 changes the operating mode of the power consuming unit 70 to the normal mode upon detecting an input from the keyboard 60.

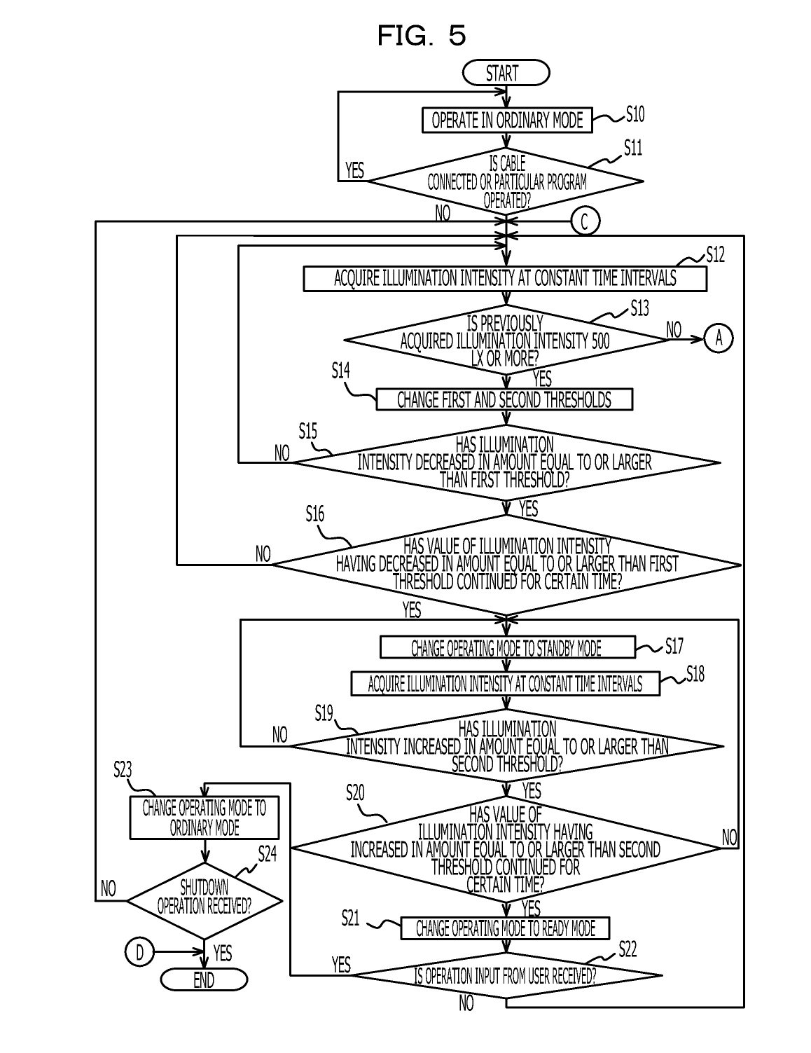

FIGS. 5 to 7 illustrate exemplary processing executed by the change unit 201.

The change unit 201 operates the power consuming unit 70 in the normal mode (operation S10).

The change unit 201 determines whether a cable is connected to the PC 100, or whether a particular program is executed (operation S11). Herein, the event of “a cable being connected to the PC 100” implies that a cable for connecting the PC 100 and a projector to each other is connected to the PC 100. The event of “a particular program being executed” implies that a program designated by the user in advance is executed. The condition used in the determination made in operation S11 is not limited to the ones described above in this embodiment. For example, whether moving images are played back, or whether a slide show is executed can also be used as the preset condition for making the determination in operation S11.

If the determination result in operation S11 is “YES”, the change unit 201 operates the power consuming unit 70 with the operating mode held in the normal mode (operation S10). On the other hand, if the determination result in operation S11 is “NO”, the change unit 201 acquires the illumination intensity at constant time intervals (e.g., 1 sec) from the photosensor 30 (operation S12).

The change unit 201 determines whether the illumination intensity acquired when it has been measured in the previous time interval is 500 lux (lx) or more (operation S13). Hereinafter, the illumination intensity acquired when it has been measured in the previous time interval is referred to as the “previously acquired illumination intensity”.

If the previously acquired illumination intensity is 500 lx or more (“YES” in operation S13), the change unit 201 changes first and second thresholds based on the previously acquired illumination intensity (operation S14). In other words, the first and second thresholds are changed based on the illumination intensity of light in the environment where the PC 100 is located. For example, the change unit 201 changes the first and second thresholds to 400 lx if the previously acquired illumination intensity is 500 lx or more.

The change unit 201 determines whether the illumination intensity acquired in the current time interval has decreased from the previously acquired illumination intensity in amount equal to or larger than the first threshold (operation S15). In other words, the change unit 201 determines whether an amount of decrease in the illumination intensity per unit time is equal to or larger than the first threshold. Hereinafter, the illumination intensity acquired in the current time interval is referred to as the “currently acquired illumination intensity”.

If the currently acquired illumination intensity has not decreased from the previously acquired illumination intensity in amount equal to or larger than the first threshold (“NO” in operation S15), the change unit 201 executes the processing from operation S12 again. On the other hand, if the currently acquired illumination intensity has decreased from the previously acquired illumination intensity in amount equal to or larger than the first threshold (“YES” operation S15), the change unit 201 determines whether a value of the illumination intensity having decreased in amount equal to or larger than the first threshold continues for a certain time (e.g., 5 sec) (operation S16). Assuming, for example, the previously acquired illumination intensity to be 850 lx, the change unit 201 determines whether a value of 450 lx or less, i.e., a value having decreased from the previously acquired illumination intensity of 850 lx in amount of 400 lx, continues for 5 sec in the illumination intensity acquired from the photosensor 30.

If the value of the illumination intensity having decreased in amount equal to or larger than the first threshold does not continue for the certain time (“NO” in operation S16), the change unit 201 executes the processing from operation S12 again. If the value of the illumination intensity having decreased in amount equal to or larger than the first threshold continues for the certain time (“YES” in operation S16), the change unit 201 changes the operating mode of the power consuming unit 70 to the standby mode (operation S17). The change unit 201 acquires the illumination intensity at the constant time intervals (operation S18).

The change unit 201 determines whether the currently acquired illumination intensity has increased from the previously acquired illumination intensity in amount equal to or larger than the second threshold (operation S19). If the currently acquired illumination intensity has not increased from the previously acquired illumination intensity in amount equal to or larger than the second threshold (“NO” in operation S19), the change unit 201 executes the processing from operation S17 again. If the currently acquired illumination intensity has increased from the previously acquired illumination intensity in amount equal to or larger than the second threshold (“YES” in operation S19), the change unit 201 determines whether a value of the illumination intensity having increased in amount equal to or larger than the second threshold continues for a certain time (operation S20).

If the value of the illumination intensity having increased in amount equal to or larger than the second threshold does not continue for the certain time (“NO” in operation S20), the change unit 201 executes the processing from operation S17 again. If the value of the illumination intensity having increased in amount equal to or larger than the second threshold continues for the certain time (“YES” operation S20), the change unit 201 changes the operating mode of the power consuming unit 70 to the ready mode (operation S21).

When the operating mode of the power consuming unit 70 is the ready mode, the change unit 201 determines whether an operation input from the user is received (operation S22). If the operation input from the user is not received (“NO” in operation S22), the change unit 201 executes the processing from operation S12 again. If the determination results from operation S13 to S15 are all “YES”, the operating mode of the power consuming unit 70 is changed from the ready mode to the standby mode.

If the operation input from the user is received (“YES” in operation S22), the change unit 201 changes the operating mode to the normal mode (operation S23). The change unit 201 determines whether a shutdown operation is received from the user (operation S24). If the shutdown operation is received from the user (“YES” in operation S24), the change unit 201 brings the processing to an end. On the other hand, if the shutdown operation is not received from the user (“NO” in operation S24), the change unit 201 executes the processing from operation S12 again.

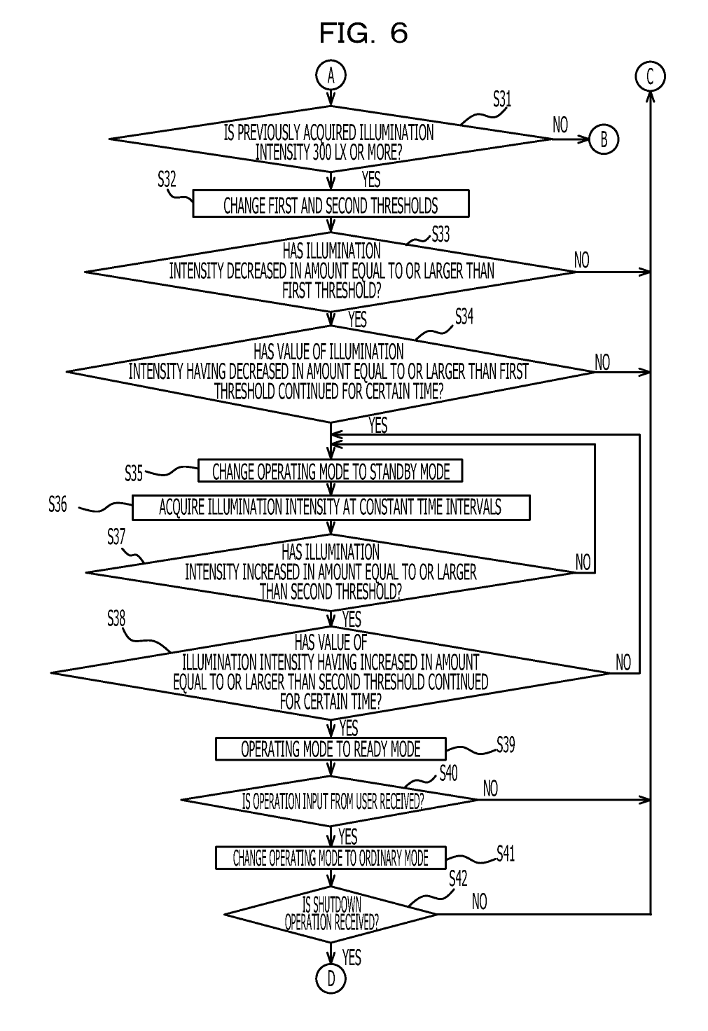

If the previously acquired illumination intensity is not 500 lx or more (“NO” in operation S13), the change unit 201 advances as denoted by A in FIG. 6 and determines whether the previously acquired illumination intensity is 300 lx or more (operation S31). If the previously acquired illumination intensity is 300 lx or more (“YES” in operation S31), the change unit 201 changes the first and second thresholds to values differing from those of the first and second thresholds which have been set in operation S14. For example, the change unit 201 changes the first and second thresholds to 200 lx on condition that the illumination intensity of light in the environment where the PC 100 is located is 300 lx or more, but less than 500 lx.

The change unit 201 determines whether the currently acquired illumination intensity has decreased from the previously acquired illumination intensity in amount equal to or larger than the first threshold (operation S33).

If the currently acquired illumination intensity has not decreased from the previously acquired illumination intensity in amount equal to or larger than the first threshold (“NO” in operation S33), the change unit 201 advances as denoted by C in FIG. 5 and executes the processing from operation 812 again. On the other hand, if the currently acquired illumination intensity has decreased from the previously acquired illumination intensity in amount equal to or larger than the first threshold (“YES” operation S33), the change unit 201 determines whether a value of the illumination intensity having decreased in amount equal to or larger than the first threshold continues for a certain time (operation 834).

If the value of the illumination intensity having decreased in amount equal to or larger than the first threshold does not continue for the certain time (“NO” in operation S34), the change unit 201 advances as denoted by C in FIG. 5 and executes the processing from operation S12 again. On the other hand, if the value of the illumination intensity having decreased in amount equal to or larger than the first threshold continues for the certain time (“YES” in operation S34), the change unit 201 changes the operating mode of the power consuming unit 70 to the standby mode (operation S35). The change unit 201 acquires the illumination intensity at the constant time intervals (operation S36).

The change unit 201 determines whether the currently acquired illumination intensity has increased from the previously acquired illumination intensity in amount equal to or larger than the second threshold (operation S37). If the currently acquired illumination intensity has not increased from the previously acquired illumination intensity in amount equal to or larger than the second threshold (“NO” in operation S37), the change unit 201 executes the processing from operation S35 again. If the currently acquired illumination intensity has increased from the previously acquired illumination intensity in amount equal to or larger than the second threshold (“YES” in operation S37), the change unit 201 determines whether a value of the illumination intensity having increased in amount equal to or larger than the second threshold continues for a certain time (operation S38).

If the value of the illumination intensity having increased in amount equal to or larger than the second threshold does not continue for the certain time (“NO” in operation S38), the change unit 201 executes the processing from operation S35 again. If the value of the illumination intensity having increased in amount equal to or larger than the second threshold continues for the certain time (“YES” operation S38), the change unit 201 changes the operating mode of the power consuming unit 70 to the ready mode (operation S39).

When the operating mode of the power consuming unit 70 is the ready mode, the change unit 201 determines whether an operation input from the user is received (operation S40). If the operation input from the user is not received (“NO” in operation S40), the change unit 201 advances as denoted by C in FIG. 5 and executes the processing from operation S12 again.

If the operation input from the user is received (“YES” in operation S40), the change unit 201 changes the operating mode to the normal mode (operation S41). The change unit 201 determines whether a shutdown operation is received from the user (operation S42). If the shutdown operation is received from the user (“YES” in operation S42), the change unit 201 advances as denoted by D in FIG. 5 and brings the processing to an end. On the other hand, if the shutdown operation is not received from the user (“NO” in operation S42), the change unit 201 advances as denoted by C in FIG. 5 and executes the processing from operation S12 again.

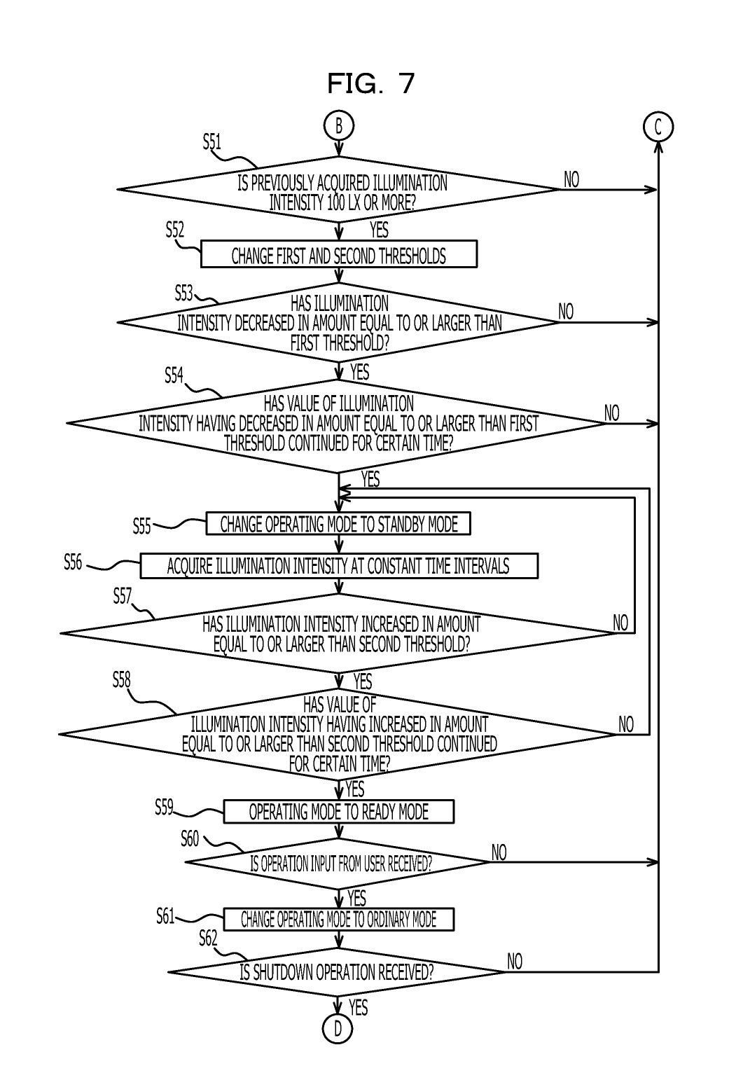

If the previously acquired illumination intensity is not 300 lx or more (“NO” in operation S31), the change unit 201 advances as denoted by B in FIG. 7 and determines whether the previously acquired illumination intensity is 100 lx or more (operation S51). If the previously acquired illumination intensity is 100 lx or more (“YES” in operation S51), the change unit 201 changes the first and second thresholds to values differing from those of the first and second thresholds which have been set in operations S14 and S32. For example, the change unit 201 changes the first and second thresholds to 100 lx on condition that the illumination intensity of light in the environment where the PC 100 is located is 100 lx or more, but less than 300 lx.

The change unit 201 determines whether the currently acquired illumination intensity has decreased from the previously acquired illumination intensity in amount equal to or larger than the first threshold (operation S53).

If the currently acquired illumination intensity has not decreased from the previously acquired illumination intensity in amount equal to or larger than the first threshold (“NO” in operation S53), the change unit 201 advances as denoted by C in FIG. 5 and executes the processing from operation S12 again. On the other hand, if the currently acquired illumination intensity has decreased from the previously acquired illumination intensity in amount equal to or larger than the first threshold (“YES” operation S53), the change unit 201 determines whether a value of the illumination intensity having decreased in amount equal to or larger than the first threshold continues for a certain time (operation S54).

If the value of the illumination intensity having decreased in amount equal to or larger than the first threshold does not continue for the certain time (“NO” in operation S54), the change unit 201 advances as denoted by C in FIG. 5 and executes the processing from operation S12 again. On the other hand, if the value of the illumination intensity having decreased in amount equal to or larger than the first threshold continues for the certain time (“YES” in operation S54), the change unit 201 changes the operating mode of the power consuming unit 70 to the standby mode (operation S55). The change unit 201 acquires the illumination intensity at the constant time intervals (operation S56).

The change unit 201 determines whether the currently acquired illumination intensity has increased from the previously acquired illumination intensity in amount equal to or larger than the second threshold (operation S57). If the currently acquired illumination intensity has not increased from the previously acquired illumination intensity in amount equal to or larger than the second threshold (“NO” in operation S57), the change unit 201 executes the processing from operation S55 again. If the currently acquired illumination intensity has increased from the previously acquired illumination intensity in amount equal to or larger than the second threshold (“YES” in operation S57), the change unit 201 determines whether a value of the illumination intensity having increased in amount equal to or larger than the second threshold continues for a certain time (operation S58).

If the value of the illumination intensity having increased in amount equal to or larger than the second threshold does not continue for the certain time (“NO” in operation S58), the change unit 201 executes the processing from operation S55 again. If the value of the illumination intensity having increased in amount equal to or larger than the second threshold continues for the certain time (“YES” operation S58), the change unit 201 changes the operating mode of the power consuming unit 70 to the ready mode (operation S59).

When the operating mode of the power consuming unit 70 is the ready mode, the change unit 201 determines whether an operation input from the user is received (operation S60). If the operation input from the user is not received (“NO” in operation S60), the change unit 201 advances as denoted by C in FIG. 5 and executes the processing from operation S12 again.

If the operation input from the user is received (“YES” in operation S60), the change unit 201 changes the operating mode to the normal mode (operation S61). The change unit 201 determines whether a shutdown operation is received from the user (operation S62).

If the shutdown operation is not received from the user (“NO” in operation S62), the change unit 201 advances as denoted by C in FIG. 5 and executes the processing from operation S12 again. On the other hand, if the shutdown operation is received from the user (“YES” in operation S62), the change unit 201 advances as denoted by D in FIG. 5 and brings the processing to an end.

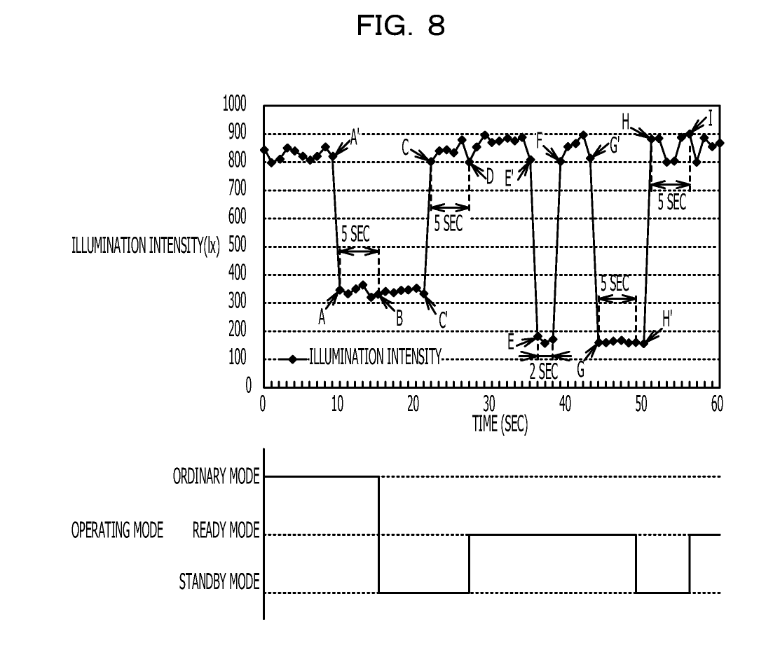

The changes of the operating mode, which are performed with the above-described processing, will be described below with reference to FIGS. 8 to 10 for PC environments is located.

FIGS. 8 to 10 illustrate a relationship between change in the illumination intensity of light in the environment where the PC, e.g., PC 100 is located and the operating mode. In FIGS. 8 to 10, an upper graph represents the relationship between the lapsed time and the illumination intensity, and a lower graph represents the relationship between the lapsed time and the operating mode.

In FIG. 8, the illumination intensity in the environment where the PC, e.g., PC 100 is located varies in the range of about 800 lx to 900 lx. Therefore, the change unit 201 changes the first and second thresholds to 400 lx depending on the illumination intensity (i.e., 500 lx or more) in the environment where the PC, e.g., PC 100 is located.

The illumination intensity in the environment where the PC, e.g., PC 100 is located decreases to a value at a time A from that at a time A′ and the difference between the previously acquired illumination intensity (at A′) and the currently acquired illumination intensity (at A) is not smaller than 400 lx. After the illumination intensity has decreased at A, the value of the illumination intensity having decreased in amount of 400 lx or more from the illumination intensity at A′ continues for the certain time (5 sec). Accordingly, the change unit 201 changes the operating mode of the power consuming unit 70 to the standby mode at a time B after the value of the illumination intensity having decreased in amount of 400 lx or more from the illumination intensity at A′ has continued for the certain time.

After the time B, the illumination intensity in the environment where the PC, e.g., PC 100 is located varies in the range of 300 lx to 400 lx. The illumination intensity increases to a value at a time C from that at a time C′ and the difference between the previously acquired illumination intensity (at C′) and the currently acquired illumination intensity (at C) is not smaller than 400 lx. After the illumination intensity has increased at C, the value of the illumination intensity having increased in amount of 400 lx or more from the illumination intensity at C′ continues for the certain time (5 sec). Accordingly, the change unit 201 changes the operating mode of the power consuming unit 70 to the ready mode at a time D after the value of the illumination intensity having increased in amount of 400 lx or more has continued for the certain time.

The illumination intensity in the environment where the PC, e.g., PC 100 is located varies in the range of 800 lx to 900 lx from the time D to E′. The illumination intensity decreases to a value at a time E from that at E′ in amount of 400 lx or more. However, the value of the illumination intensity having decreased in amount of 400 lx or more from the illumination intensity at E′ continues just for 2 sec, and the illumination intensity is increased to about 800 lx at a time F after 3 sec from E. Accordingly, the change unit 201 keeps the operating mode of the power consuming unit 70 remained in the ready mode for the reason that the value of the illumination intensity having decreased in amount of 400 lx or more from the illumination intensity at E′ has not continued for the certain time.

The illumination intensity in the environment where the PC, e.g., PC 100 is located decreases to a value at a time G from that at a time G′ and the currently acquired illumination intensity (at G) takes a value having decreased in amount of 400 lx or more from the previously acquired illumination intensity (at G′). After the illumination intensity has decreased at G, the value of the illumination intensity having decreased in amount of 400 lx or more from the illumination intensity at G′ continues for the certain time. Accordingly, the change unit 201 changes the operating mode of the power consuming unit 70 to the standby mode again at a time after the value of the illumination intensity having decreased in amount of 400 lx or more has continued for the certain time.

Further, the illumination intensity in the environment where the PC, e.g., PC 100 is located increases to a value at a time H from that at a time H′ and the difference between the previously acquired illumination intensity (at H′) and the currently acquired illumination intensity (at H) is not smaller than 400 lx. After the illumination intensity has increased at H, the value of the illumination intensity having increased in amount of 400 lx or more from the illumination intensity at H′ continues for the certain time. Accordingly, the change unit 201 changes the operating mode of the power consuming unit 70 to the ready mode at a time I after the value of the illumination intensity having increased in amount of 400 lx or more from the illumination intensity at H′ has continued for the certain time.

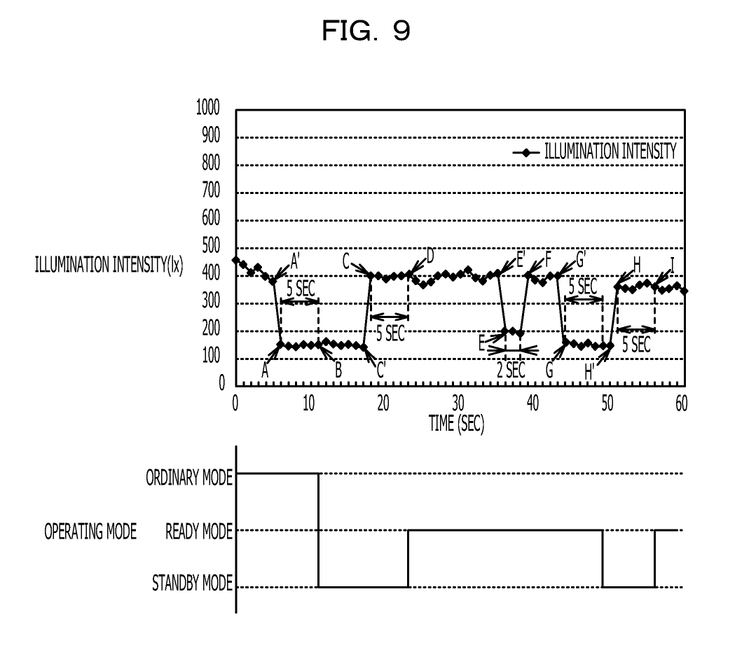

The case where the illumination intensity in the environment where the PC, e.g., PC 100 is located is lower than in the case illustrated in FIG. 8 will be described below with reference to FIG. 9. In FIG. 9, the illumination intensity in the environment where the PC, e.g., PC 100 is located varies in the range of about 350 lx to 500 lx. Therefore, the change unit 201 changes the first and second thresholds to 200 lx depending on the illumination intensity (i.e., 300 lx or more, but less than 500 lx) in the environment where the PC, e.g., PC 100 is located.

The illumination intensity in the environment where the PC, e.g., PC 100 is located decreases to a value at a time A from that at a time A′ and the difference between the previously acquired illumination intensity (at A′) and the currently acquired illumination intensity (at A) is not smaller than 200 lx. After the illumination intensity has decreased at A, the value of the illumination intensity having decreased in amount of 200 lx or more from the illumination intensity at A′ continues for the certain time (5 sec). Accordingly, the change unit 201 changes the operating mode of the power consuming unit 70 to the standby mode at a time B after the value of the illumination intensity having decreased in amount of 200 lx or more from the illumination intensity at A′ has continued for the certain time.

After the time B, the illumination intensity in the environment where the PC, e.g., PC 100 is located varies in the range of 100 lx to 200 lx. The illumination intensity increases to a value at a time C from that at a time C′ and the difference between the previously acquired illumination intensity (at C′) and the currently acquired illumination intensity (at C) is not smaller than 200 lx. After the illumination intensity has increased at C, the value of the illumination intensity having increased in amount of 200 lx or more from the illumination intensity at C′ continues for the certain time (5 sec). Accordingly, the change unit 201 changes the operating mode of the power consuming unit 70 to the ready mode at a time D after the value of the illumination intensity having increased in amount of 200 lx or more from the illumination intensity at C′ has continued for the certain time.

The illumination intensity in the environment where the PC, e.g., PC 100 is located varies in the range of 350 lx to 450 lx from the time D to E′. The illumination intensity decreases to a value at a time E from that at E′ in amount of 200 lx or more. However, the value of the illumination intensity having decreased in amount of 200 lx or more from the illumination intensity at E′ continues just for 2 sec, and the illumination intensity is increased to about 400 lx at a time F after 3 sec from E. Accordingly, the change unit 201 keeps the operating mode of the power consuming unit 70 remained in the ready mode for the reason that the value of the illumination intensity having decreased in amount of 200 lx or more from the illumination intensity at E′ has not continued for the certain time.

The illumination intensity in the environment where the PC, e.g., PC 100 is located decreases to a value at a time G from that at a time G′ and the currently acquired illumination intensity (at G) takes a value having decreased in amount of 200 lx or more from the previously acquired illumination intensity (at G′). After the illumination intensity has decreased at G, the value of the illumination intensity having decreased in amount of 200 lx or more from the illumination intensity at G′ continues for the certain time. Accordingly, the change unit 201 changes the operating mode of the power consuming unit 70 to the standby mode again at a time after the value of the illumination intensity having decreased in amount of 200 lx or more has continued for the certain time.

Further, the illumination intensity in the environment where the PC, e.g., PC 100 is located increases to a value at a time H from that at a time H′ and the difference between the previously acquired illumination intensity (at H″) and the currently acquired illumination intensity (at H) is not smaller than 200 lx. After the illumination intensity has increased at H, the value of the illumination intensity having increased in amount of 200 lx or more from the illumination intensity at H′ continues for the certain time. Accordingly, the change unit 201 changes the operating mode of the power consuming unit 70 to the ready mode at a time I after the value of the illumination intensity having increased in amount of 200 lx or more from the illumination intensity at H′ has continued for the certain time.

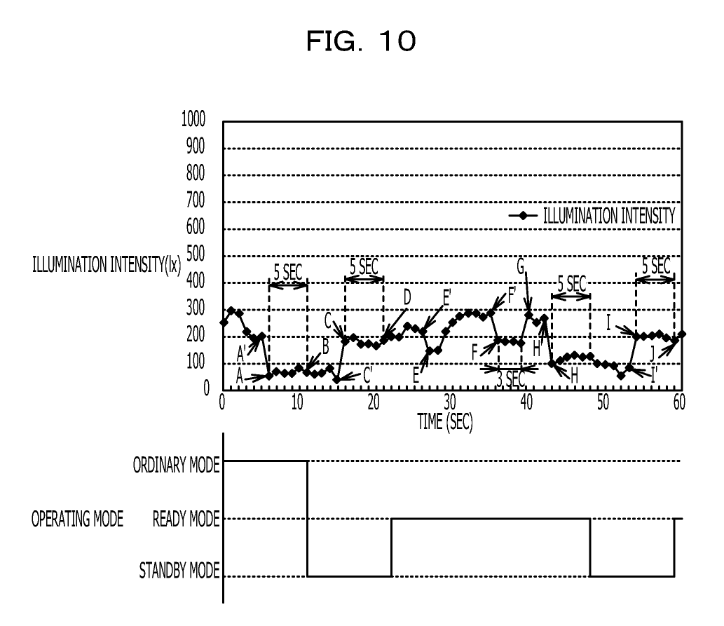

The case where the illumination intensity in the environment where the PC, e.g., PC 100 is located is lower than in the cases illustrated in FIGS. 8 and 9 will be described below with reference to FIG. 10. In FIG. 10, the illumination intensity in the environment where the PC, e.g., PC 100 is located varies in the range of about 200 lx to 300 lx. Therefore, the change unit 201 changes the first and second thresholds to 100 lx depending on the illumination intensity (i.e., 100 lx or more, but less than 300 lx) in the environment where the PC, e.g., PC 100 is located.

The illumination intensity in the environment where the PC, e.g., PC 100 is located decreases to a value at a time A from that at a time A′ and the difference between the previously acquired illumination intensity (at A′) and the currently acquired illumination intensity (at A) is not smaller than 100 lx. After the illumination intensity has decreased at A, the value of the illumination intensity having decreased in amount of 100 lx or more from the illumination intensity at A′ continues for the certain time (5 sec). Accordingly, the change unit 201 changes the operating mode of the power consuming unit 70 to the standby mode at a time B after the value of the illumination intensity having decreased in amount of 100 lx or more from the illumination intensity at A′ has continued for the certain time.

After the time B, the illumination intensity in the environment where the PC, e.g., PC 100 is located varies in the range of 0 lx to 100 lx. The illumination intensity increases to a value at a time C from that at a time C′ and the difference between the previously acquired illumination intensity (at C′) and the currently acquired illumination intensity (at C) is not smaller than 100 lx. After the illumination intensity has increased at C, the value of the illumination intensity having increased in amount of 100 lx or more from the illumination intensity at C′ continues for the certain time (5 sec). Accordingly, the change unit 201 changes the operating mode of the power consuming unit 70 to the ready mode at a time D after the value of the illumination intensity having increased in amount of 100 lx or more from the illumination intensity at C′ has continued for the certain time.

The illumination intensity in the environment where the PC, e.g., PC 100 is located varies in the range of 180 lx to 250 lx from the time D to E′. It is here assumed that the change unit 201 changes the first and second thresholds to 100 lx depending on the illumination intensity (i.e., 100 lx or more, but less than 300 lx) in the environment where the PC, e.g., PC 100 is located.

The illumination intensity in the environment where the PC, e.g., PC 100 is located decreases to a value at a time E from that at E′. However, the difference between the previously acquired illumination intensity (at E′) and the currently acquired illumination intensity (at E) is neither equal to nor larger than 100 lx. Accordingly, the change unit 201 keeps the operating mode of the power consuming unit 70 remained in the ready mode.

The illumination intensity in the environment where the PC, e.g., PC 100 is located decreases to a value at a time F from that at a time F′ and the currently acquired illumination intensity (at F) takes a value having decreased in amount of 100 lx or more from the previously acquired illumination intensity (at F′). However, the value of the illumination intensity having decreased in amount of 100 lx or more from the illumination intensity at F′ continues just for 3 sec, and the illumination intensity is increased to about 300 lx at a time G after 4 sec from F. Accordingly, the change unit 201 keeps the operating mode of the power consuming unit 70 remained in the ready mode for the reason that the value of the illumination intensity having decreased in amount of 100 lx or more from the illumination intensity at F′ has not continued for the certain time.

The illumination intensity in the environment where the PC, e.g., PC 100 is located decreases to a value at a time H from that at a time H′ and the currently acquired illumination intensity (at H) takes a value having decreased in amount of 100 lx or more from the previously acquired illumination intensity (at H′). Further, after the illumination intensity has decreased at H, the value of the illumination intensity having decreased in amount of 100 lx or more from the illumination intensity at H′ continues for the certain time. Accordingly, the change unit 201 changes the operating mode of the power consuming unit 70 to the standby mode again at a time after the value of the illumination intensity having decreased in amount of 100 lx or more from the illumination intensity at H′ has continued for the certain time.

The illumination intensity in the environment where the PC, e.g., PC 100 is located increases to a value at a time I from that at a time I′ and the difference between the previously acquired illumination intensity (at I′) and the currently acquired illumination intensity (at I) is not smaller than 100 lx. After the illumination intensity has increased at I, the value of the illumination intensity having increased in amount of 100 lx or more from the illumination intensity at continues for the certain time. Accordingly, the change unit 201 changes the operating mode of the power consuming unit 70 to the ready mode at a time J after the value of the illumination intensity having increased in amount of 100 lx or more from the illumination intensity at I′ has continued for the certain time.

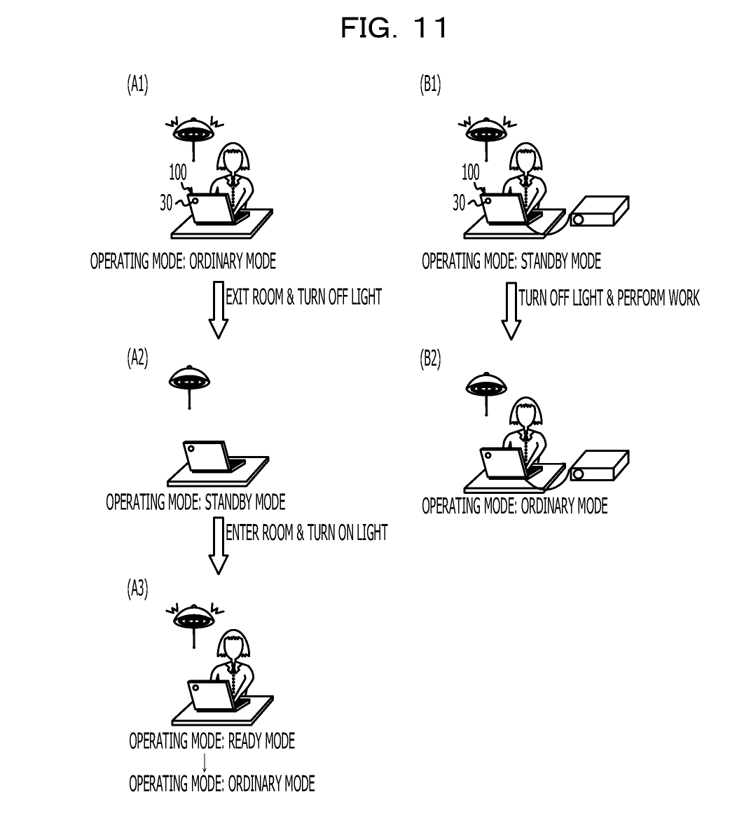

The operating mode of the PC, e.g., PC 100, which is located through the above-described processing, will be briefly described below with reference to FIG. 11. FIG. 11 illustrates changes of the operating mode of the PC, e.g., PC 100 with respect to an ambient environment and user work.

(A1) in FIG. 11 illustrates a state where illumination in a room is turned on and the user performs work using the PC, e.g., PC 100. In such a state, the operating mode of the PC, e.g., PC 100 is located to the normal mode.

Let now assume that the user leaves the PC, e.g., PC 100 without turning off the power and turns off the illumination when exiting the room. (A2) in FIG. 11 illustrates a state where the illumination in the room is turned off and the user does not use the PC, e.g., PC 100. If an amount of decrease in the illumination intensity detected by the photosensor 30 per unit time is equal to or larger than the first threshold at the time of transition from (A1) to (A2) in FIG. 11, the operating mode of the PC, e.g., PC 100 is changed to the standby mode as indicated at (A2) in FIG. 11.

Let assume that the user then enters the room, turns on the illumination, and starts to operate the PC, e.g., PC 100. (A3) in FIG. 11 illustrates a state where the illumination in the room is turned on and the user is going to operate the PC, e.g., PC 100. If an amount of increase in the illumination intensity detected by the photosensor 30 per unit time is equal to or larger than the second threshold at the time of transition from (A2) to (A3) in FIG. 11, the operating mode of the PC, e.g., PC 100 is changed to the ready mode. Thereafter, when the operation of the PC, e.g., PC 100 by the user is detected, the operating mode of the PC, e.g., PC 100 is changed to the normal mode.

(B1) in FIG. 11 illustrates a state where the illumination in the room is turned on and the user performs work with the PC, e.g., PC 100 connected to a projector. In such a state, the operating mode of the PC, e.g., PC 100 is located to the normal mode.

Let now assume that the user turns off the illumination in the room. (B2) in FIG. 11 illustrates a state where the illumination in the room is turned off and the user continues the work with the PC, e.g., PC 100 kept connected to the projector. It is here assumed that, at the time of transition from the state (B1) to (B2) in FIG. 11, an amount of decrease in the illumination intensity detected by the photosensor 30 per unit time is equal to or larger than the first threshold. In such a case, although the amount of decrease in the illumination intensity detected by the photosensor 30 per unit time is equal to or larger than the first threshold, the operating mode of the PC, e.g., PC 100 is not changed to the standby mode, but it is remained in the normal mode as illustrated at (62) in FIG. 11 because a cable is connected to the PC, e.g., PC 100.

According to an exemplary embodiment, when the amount of decrease in the illumination intensity per unit time, which is calculated from the illumination intensity detected by the photosensor 30, is equal to or larger than the first threshold, the change unit 201 changes the operating mode of the power consuming unit 70 to the standby mode. In other words, the change unit 201 determines based on the amount of decrease in the illumination intensity per unit time, instead of the illumination intensity acquired from the photosensor 30, whether the operating mode is to be changed. Therefore, even when the illumination intensity in a surrounding area of the set PC, e.g., PC 100 is low, i.e., even when the surrounding area is dark, the operating mode of the power consuming unit 70 is not changed to the standby mode and the convenience for the user is increased. On the other hand, even when a period during which the operation input from the user is not received does not exceed a certain time, the power consuming unit 70 is changed to the standby mode if the amount of decrease in the illumination intensity per unit time is equal to or larger than the first threshold. Therefore, a power-saving effect is increased. Further, since the change unit 201 changes the operating mode of the power consuming unit 70 to the standby mode by detecting such a situation that the illumination intensity is greatly changed in a moment, power-saving control can be executed in a manner capable of reducing the influence of brightness in the outdoor, which gently changes depending on the weather and time zones in a day.

According to an exemplary embodiment, when the operating mode of the power consuming unit 70 is in the normal mode or the ready mode, the change unit 201 changes the operating mode of the power consuming unit 70 to the standby mode based on the amount of decrease in the illumination intensity per unit time. The power consumed by the PC, e.g., PC 100 can be reduced by prolonging a duration time of the standby mode. In this respect, more specifically, the power consumed by the PC, e.g., PC 100 is greatly affected by a period from the time at which the user has stopped the operation of the PC, e.g., PC 100 to the time at which the operating mode of the power consuming unit 70 is actually changed from the normal mode to the standby mode. By employing the amount of decrease in the illumination intensity per unit time as in an exemplary embodiment, the timing of stopping the operation of the PC, e.g., PC 100 by the user can be detected with higher reliability. As a result, the period from the time at which the user has stopped the operation of the PC, e.g., PC 100 to the time at which the operating mode of the power consuming unit 70 is actually changed from the normal mode to the standby mode can be shortened, whereby a higher power-saving effect can be obtained.

According to an exemplary embodiment, when a particular program is executed or when a cable is connected to the PC, e.g., PC 100, the change unit 201 keeps the power consuming unit 70 operated in the normal mode without changing the operating mode to the power-saving mode even when the amount of decrease in the illumination intensity per unit time is equal to or larger than the first threshold. As a result, the power-saving control can be executed in a way adapted for use environments of the PC, e.g., PC 100 depending on individual users, and the convenience for the users can be increased.

According to an exemplary embodiment, the change unit 201 changes the first and second thresholds depending on the illumination intensity of light in the environment where the PC, e.g., PC 100 is located. Therefore, the operating mode can be changed depending on the environment where the PC, e.g., PC 100 is located. For example, when the environment where the PC, e.g., PC 100 is located is bright, the change unit 201 sets the thresholds in consideration of the influence of brightness in the outdoor, which changes depending on the weather and time zones in a day. This reduces a possibility that the operating mode of the power consuming unit 70 is changed to the standby mode at the timing not expected by the user. As a result, the convenience for the user is increased. Further, by properly setting the threshold in the case where the illumination intensity is low, the power consumption can be controlled to be reduced even when the environment where the PC, e.g., PC 100 is located is dark, whereby the power-saving effect can be increased. The change unit 201 may change one of the first and second thresholds depending on the illumination intensity of light in the environment where the PC, e.g., PC 100 is located.

According to an exemplary embodiment, the change unit 201 changes the operating mode to the standby mode on condition that the amount of decrease in the illumination intensity per unit time is equal to or larger than the first threshold and that the value of the illumination intensity having decreased in amount equal to or larger than the first threshold from the previously acquired illumination intensity has continued for the certain time (5 sec). With that feature, the operating mode of the power consuming unit 70 is not changed to the standby mode when the illumination intensity in the room where the PC, e.g., PC 100 is located is temporarily turned down (darkened). In other words, when the illumination is turned off by mistake, for example, the PC, e.g., PC 100 is not changed to the standby mode. As a result, the convenience for the user can be increased.

According to an exemplary embodiment, the change unit 201 changes the operating mode to the ready mode on condition that the amount of increase in the illumination intensity per unit time is equal to or larger than the second threshold and that the value of the illumination intensity having increased in amount equal to or larger than the second threshold from the previously acquired illumination intensity has continued for the certain time (5 sec). With that feature, the operating mode of the power consuming unit 70 is not changed to the ready mode when the illumination intensity in the room where the PC, e.g., PC 100 is located is temporarily turned up (brightened). Let assume, for example, that after the illumination in the environment where the PC, e.g., PC 100 is located has been turned off, the illumination is temporarily turned on again for some reason, e.g., the reason that the user gets back to the room for a thing left there. In such a case, unless a time during which the illumination is temporarily turned on does not exceed the certain time, the operating mode is kept remained in the standby mode. Hence, the power-saving effect can be further increased. In an exemplary embodiment described above, the certain time used in determining whether the operating mode is to be changed from the normal mode to the standby mode and the certain time used in determining whether the operating mode is to be changed from the standby mode to the ready mode are set to the same value, i.e., 5 sec. However, the certain times used in those determinations are not always required to be the same. For example, the certain time used in determining whether the operating mode is to be changed from the normal mode to the standby mode may be set to 3 sec, and the certain time used in determining whether the operating mode is to be changed from the standby mode to the ready mode may be set to 20 sec. That setting shortens a time lapsed until the operating mode is changed from the normal mode to the standby mode, and further increases a probability that the standby mode is continued. As a result, a higher power-saving effect can be expected.

According to an exemplary embodiment, when the operating mode of the power consuming unit 70 is in the power-saving mode, the change unit 201 changes the operating mode of the power consuming unit 70 to the ready mode on condition that the amount of increase in the illumination intensity per unit time is equal to or larger than the second threshold. Since the power consumption in the ready mode is smaller than that in the normal mode, it is possible to prevent the power consumption from being increased with the operating mode transited to the normal mode regardless of that the user is not going to use the PC, e.g., PC 100, and to increase the power-saving effect. In the ready mode, since the information processing unit 20 operates in the normal mode, the user can start the operation using the PC, e.g., PC 100 at once by manipulating the keyboard 60, the mouse, or the like. As a result, the convenience for the user using the PC, e.g., PC 100 can be increased.

In an exemplary embodiment, the change unit 201 determines whether the operating mode is to be changed to the standby mode, by employing, as determination conditions, whether the amount of decrease in the illumination intensity per unit time is equal to or larger than the first threshold and whether the value of the illumination intensity having decreased in amount equal to or larger than the first threshold from the previously acquired illumination intensity has continued for the certain time. However, the determination condition of whether the value of the illumination intensity having decreased in amount equal to or larger than the first threshold from the previously acquired illumination intensity has continued for the certain time is not always required. In other words, the change unit 201 may change the operating mode of the power consuming unit 70 to the standby mode based on only the result of the determination as to whether the amount of decrease in the illumination intensity per unit time is equal to or larger than the first threshold.

In an exemplary embodiment, the change unit 201 determines whether the operating mode is to be changed to the ready mode, by employing, as determination conditions, whether the amount of increase in the illumination intensity per unit time is equal to or larger than the second threshold and whether the value of the illumination intensity having increased in amount equal to or larger than the second threshold from the previously acquired illumination intensity has continued for the certain time. However, the determination condition of whether the value of the illumination intensity having increased in amount equal to or larger than the second threshold from the previously acquired illumination intensity has continued for the certain time is not always required. In other words, the change unit 201 may change the operating mode of the power consuming unit 70 to the ready mode based on only the result of the determination as to whether the amount of increase in the illumination intensity per unit time is equal to or larger than the second threshold.

Further, the change unit 201 may employ, as the additional determination condition, whether the value of the illumination intensity having decreased in amount equal to or larger than the first threshold from the previously acquired illumination intensity has continued for the certain time, only when it determines whether the operating mode is to be changed to the standby mode. The change unit 201 may employ, as the additional determination condition, whether the value of the illumination intensity having increased in amount equal to or larger than the second threshold from the previously acquired illumination intensity has continued for the certain time, only when it determines whether the operating mode is to be changed to the ready mode. In any case, the change unit 201 may determine the operating mode of the power consuming unit 70 based on only the amount of decrease or the amount of increase in the illumination intensity per unit time.

In an exemplary embodiment, as described above with reference to FIGS. 5 to 7, whether the previously acquired illumination intensity is 500 lx or more, 300 lx or more, and 100 lx or more are employed as the determination conditions for changing the first and second thresholds. However, the previously acquired illumination intensity used as the determination condition for changing the first and second thresholds is not limited to the above-mentioned values. For example, whether the previously acquired illumination intensity is 400 lx or more, 200 lx or more, and 50 lx or more may be employed as the determination conditions for changing the first and second thresholds.

While an exemplary embodiment has been fully described above in connection with particular examples of the electronic apparatus, the electronic apparatus is not limited to the particular examples and can be variously modified and altered without departing from the scope of the present invention defined in claims.

The electronic apparatus can be practiced as a digital photo-frame for displaying digital image data, a copying machine, a facsimile, a scanner, and a multi-function peripheral (composite device).

While an exemplary embodiment has been described in connection with the case where the power consuming unit 70 includes the liquid crystal display unit 10 and the information processing unit 20, the power consuming unit 70 may include only the liquid crystal display unit 10. In such a case, operating states can be defined as follows. A normal state represents a state where an input video signal is displayed on the liquid crystal display unit 10. A ready state represents a state where any video signal is not displayed on the liquid crystal display unit 10. A power-saving state represents a state where supply of power to the liquid crystal display unit 10 is stopped.

Alternatively, the power consuming unit 70 may include only the information processing unit 20. In such a case, operating states can be defined as follows. An normal state represents a state where the processes instructed from the user can be all executed. A ready state represents a state where the information processing unit 20 is operated with the number of clocks in the CPU 22 set to be lower than that in the normal state. A power-saving state represents a state where supply of power to various components of the information processing unit 20 is stopped.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention. The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An electronic apparatus comprising:
a power consuming unit that consumes electric power with operation of the electronic apparatus;
a detection unit that detects illumination intensity of light in an environment where the electronic apparatus is located; and
a change unit that changes an operating state of the power consuming unit from a first state to a second state when an amount of change in the illumination intensity that is calculated from the illumination intensity detected by the detection unit, is equal to or larger than a predetermined threshold.

2. The electronic apparatus according to claim 1, wherein the predetermined threshold is a first threshold,
the first state is an normal operating state,
the second state is a power-saving state in which power consumption is lower than that in the normal operating state, and
the change unit changes the operating state of the power consuming unit from the normal operating state to the power-saving state when the change in the illumination intensity is a decrease in amount equal to or larger than the first threshold.

3. The electronic apparatus according to claim 2, wherein in the case of a preset condition being satisfied, the change unit inhibits a change from the normal operating state to the power-saving state even when the change in the illumination intensity is a decrease in amount equal to or larger than the first threshold.

4. The electronic apparatus according to claim 1, wherein the change unit changes the predetermined threshold based on the illumination intensity of light, which is detected by the detection unit.

5. The electronic apparatus according to claim 1, wherein the change unit changes the operating state of the power consuming unit from the first state to the second state when the amount of change in the illumination intensity is equal to or larger than the predetermined threshold and when a difference between a current value of the illumination intensity and a value of the illumination intensity at start of the change is equal to or larger than the predetermined threshold and the difference has continued for a certain time after the change.

6. The electronic apparatus according to claim 1, wherein the predetermined threshold is a second threshold,
the first state is a power-saving state,
the second state is a ready state in which power consumption is lower than that in the normal operating state, but higher than that in the power-saving state, and
the change unit changes the operating state of the power consuming unit from the power-saving state to the ready state when the change in the illumination intensity is an increase in amount equal to or larger than the second threshold.

7. The electronic apparatus according to claim 1, wherein the power consuming unit includes at least one of a display unit and an information processing unit.

8. The electronic apparatus according to claim 6, wherein the power consuming unit includes a display unit and an information processing unit, and
the ready state represents a situation that an operating state of the display unit is in the power-saving state and an operating state of the information processing unit is in the normal operating state.

9. A state control method executed by an apparatus, the method comprising:
consuming power with operation of the apparatus by a power consuming unit;
detecting illumination intensity of light in an environment where the apparatus is located; and
changing an operating state of the power consuming unit based on a comparison of an amount of change in the illumination intensity that is calculated from the detected illumination intensity and a predetermined threshold.

10. The state control method according to claim 9, wherein the predetermined threshold is a first threshold,
the first state is an normal operating state,
the second state is a power-saving state in which power consumption is lower than that in the normal operating state, and
the operating state is changed from the normal operating state to the power-saving state when the change in the illumination intensity is a decrease in amount equal to or larger than the first threshold.

11. The state control method according to claim 10, wherein in the case of a preset condition being satisfied, a change from the normal operating state to the power-saving state is inhibited even when the change in the illumination intensity is a decrease in amount equal to or larger than the first threshold.

12. The state control method according to claim 9, wherein the predetermined threshold is changed based on the detected illumination intensity of light.

13. The state control method according to claim 9, wherein the operating state of the power consuming unit is changed from the first state to the second state when the amount of change in the illumination intensity is equal to or larger than the predetermined threshold and when a difference between a current value of the illumination intensity and a value of the illumination intensity at start of the change is equal to or larger than the predetermined threshold and the difference has continued for a certain time after the change.

14. The state control method according to claim 9, wherein the predetermined threshold is a second threshold,
the first state is a power-saving state,
the second state is a ready state in which power consumption is lower than that in the normal operating state, but higher than that in the power-saving state, and
the operating state is changed from the power-saving state to the ready state when the change in the illumination intensity is an increase in amount equal to or larger than the second threshold.

15. A non-transitory recording medium which is computer-readable and records a program executed by an electronic apparatus, the program causing the electronic apparatus to execute a state control method comprising:
consuming electric power with operation of the electronic apparatus by a power consuming unit;
detecting illumination intensity of light in an environment where the electronic apparatus is located; and
changing an operating state of the power consuming unit from a first state to a second state when an amount of change in the illumination intensity, that is calculated from the detected illumination intensity, is equal to or larger than a predetermined threshold.

16. The recording medium according to claim 15, wherein the predetermined threshold is a first threshold,
the first state is an normal operating state,
the second state is a power-saving state in which power consumption is lower than that in the normal operating state, and
the operating state is changed from the normal operating state to the power-saving state when the change in the illumination intensity is a decrease in amount equal to or larger than the first threshold.

17. The recording medium according to claim 16, wherein in the case of a preset condition being satisfied, a change from the normal operating state to the power-saving state is inhibited even when the change in the illumination intensity is a decrease in amount equal to or larger than the first threshold.

18. The recording medium according to claim 15, wherein the predetermined threshold is changed based on the detected illumination intensity of light.

19. The recording medium according to claim 15, wherein the operating state of the power consuming unit is changed from the first state to the second state when the amount of change in the illumination intensity is equal to or larger than the predetermined threshold and when a difference between a current value of the illumination intensity and a value of the illumination intensity at start of the change is equal to or larger than the predetermined threshold and the difference has continued for a certain time after the change.

20. The recording medium according to claim 15, wherein the predetermined threshold is a second threshold,
the first state is a power-saving state,
the second state is a ready state in which power consumption is lower than that in the normal operating state, but higher than that in the power-saving state, and
the operating state is changed from the power-saving state to the ready state when the change in the illumination intensity is an increase in amount equal to or larger than the second threshold.
